(19) United States
(12) Patent Application Publication
(10) Pub. No.: US 2017/0344330 A1
(43) Pub. Date: Nov. 30, 2017

(54) MULTI-DISPLAY DEVICE

(71) Applicant: Panasonic Intellectual Property Management Co., Ltd., Osaka (JP)

(72) Inventor: JUNJI MASUMOTO, Osaka (JP)

(21) Appl. No.: 15/425,193

(22) Filed: Feb. 6, 2017

(30) Foreign Application Priority Data
May 31, 2016 (JP) 2016-108086
Jan. 13, 2017 (JP) 2017-003808

(51) Int. Cl. G06F 3/14; G09G 5/12; G09G 5/00; G09G 5/373

(52) U.S. Cl. CPC G06F 3/1446; G09G 5/006; G09G 5/12; G06F 3/1431; G09G 2310/08; G09G 5/373; G09G 2340/04; G09G 2360/04; G09G 2370/02; G09G 2300/026

(57) ABSTRACT

A multi-display device includes a plurality of displays that are connected through a network to enable the plurality of displays to communicate with each other. In the multi-display device, the respective displays decode the same video content item transmitted to the respective displays, identify respective desired areas based on arrangements of the respective displays in the multi-display device, and display respective images located in the identified areas in the same timing.

### BACKGROUND

### 1. Technical Field

The present disclosure relates to a multi-display device.

### 2. Description of the Related Art

Unexamined Japanese Patent Publication No. 2003-208145 discloses a multi-display device that displays one video on a plurality of displays without using a dividing device for dividing an input video signal. This multi-display device calculates a sampling starting position and a cut-out area for each display on the basis of information about user-designated vertical and horizontal numbers of displays. In addition to the calculation, the multi-display device calculates cut-out area magnification factor information on the basis of the resolution of a video area of the input video signal and the user-designated vertical and horizontal numbers of displays. Subsequently, the multi-display device displays a desired magnified video signal. As the result, even if the dividing device is not used, the multi-display device is capable of displaying one video on the plurality of displays as a whole without causing a sense of discomfort.

### SUMMARY

According to Unexamined Japanese Patent Publication No. 2003-208145, a cut-out signal is generated on the basis of a horizontal synchronizing signal and a vertical synchronizing signal, and a video signal that has been input when the cut-out signal is enabled is cut out to display a desired cut-out area. If the cut-out signal is generated by such a method, when a video content item subjected to image compression, such as JPEG and MPEG, is input, a desired cut-out signal cannot be generated. In addition, the decoding time of the video content item subjected to image compression differs on a display basis, and therefore a phenomenon in which the display timings of cut-out videos are out of synchronization occurs.

The present disclosure provides a multi-display device including a plurality of displays that are connected through a network to enable the plurality of displays to communicate with each other, wherein only respective desired areas based on arrangements of the respective displays are extracted from the same video content item input into the respective displays, and the display timings of the respective displays are synchronized with each other.

The present disclosure presents a multi-display device that combines a plurality of displays, which are connected to each other through a network, to display one video. The plurality of displays are each provided with: a communicator that is capable of communicating through the network; a video processor that decodes an arbitrary video content item, and identifies a display area based on an arrangement of each display; a display unit that displays an image located in the area identified by the video processor; a time synchronizer that synchronizes, through the communicator, the timing of displaying the image by the display unit between the plurality of displays; and a controller that controls the communicator, the video processor, the display unit, and the time synchronizer.

The multi-display device according to the present disclosure is effective for easily displaying one content item on the plurality of displays as a whole with the display timings synchronized without using a dividing device for dividing the video content item.

### BRIEF DESCRIPTION OF THE DRAWINGS

FIG. 1 is a configuration diagram of a multi-display device according to a first exemplary embodiment;

FIG. 2 is a block diagram illustrating a configuration of a display according to the first exemplary embodiment;

FIG. 3 is a flowchart illustrating the operation of the multi-display device according to the first exemplary embodiment;

FIG. 4 is a diagram illustrating the operation of a video processor of the display according to the first exemplary embodiment;

FIG. 5 is a diagram illustrating the operation of the video processor of the display according to the first exemplary embodiment;

FIG. 6 is a block diagram illustrating a configuration of a modified example of the multi-display device according to the first exemplary embodiment; and

FIG. 7 is a flowchart illustrating the operation of a multi-display device according to a second exemplary embodiment.

### DETAILED DESCRIPTION

Exemplary embodiments will be described in detail below with reference to the drawings as appropriate. It is noted that a more detailed description than need may be omitted. For example, the detailed description of already well-known matters and the overlap description of substantially same configurations may be omitted. This is to avoid an unnecessarily redundant description below and to facilitate understanding of a person skilled in the art.

Incidentally, the attached drawings and the following description are provided for those skilled in the art to fully understand the present disclosure, and are not intended to limit the subject matter as described in the appended claims.

### First Exemplary Embodiment

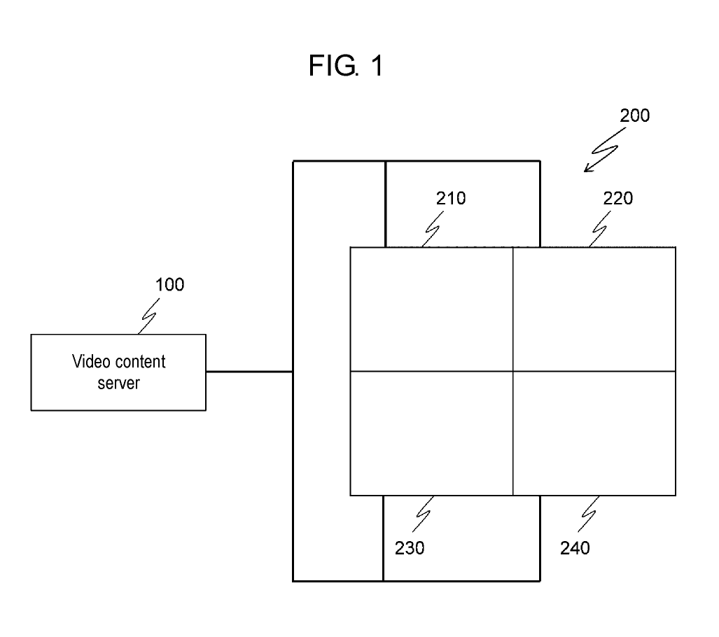

A first exemplary embodiment will be described below with reference to FIGS. 1 to 5.

### 1-1. Configuration

FIG. 1 is a configuration diagram of a multi-display device according to the first exemplary embodiment.

In FIG. 1, video content server 100 transmits an arbitrary video content item to each of displays that are each connected to video content server 100 through a network. In general, a network bandwidth is limited, and therefore a video content item to be transmitted from video content server 100 is compressed to have an appropriate file size, and is then transmitted through the network. Displays 210, 220, 230, and 240 are each connected to video content server 100 through the network, and are capable of communicating with one another through the network.

Thus, multi-display device 200 is configured by combining the plurality of displays 210 to 240, which are connected through the network, to display one video.

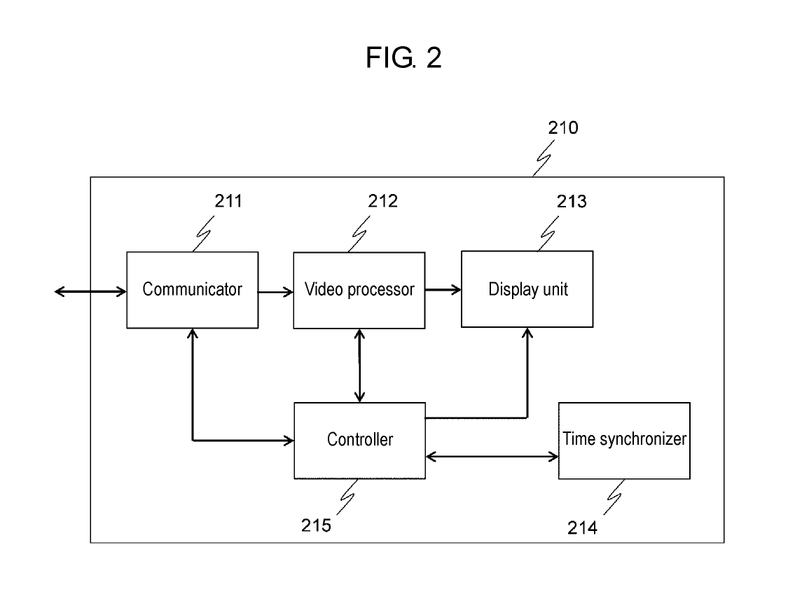

FIG. 2 is a block diagram illustrating a configuration of each of the displays. The displays each have the same configuration; and FIG. 2 illustrates display 210 in FIG. 1 as a representative of the displays.

Display 210 is provided with communicator 211, video processor 212, display unit 213, time synchronizer 214, and controller 215.

Communicator 211 performs communications through the network. Communicator 211 receives the video content item from video content server 100, and video processor 212 then cuts out, from the video content item, a predetermined display area at desired magnification factors to generate an image. Display unit 213 displays the image generated by video processor 212. Time synchronizer 214 adjusts and synchronizes the time with the time of each of the other displays 220, 230 and 240 through the network to carry out the time management. Controller 215 controls communicator 211, video processor 212, display unit 213, and time synchronizer 214. Controller 215 is composed of, for example, a microcomputer.

The configuration of this display is shared between the first exemplary embodiment and a second exemplary embodiment.

In order to simplify the description, FIG. 1 shows an example in which four displays 210 to 240 constitute one screen (video). However, there are many variations in a number of displays and in how to combine the displays, and therefore the configuration of the multi-display device is not limited to that shown in the first exemplary embodiment. In addition, FIG. 1 shows an example in which video content server 100 is directly connected to each of displays 210 to 240 through the network. However, a configuration in which a network repeater such as a switching hub and a network router is inserted therebetween may be used.

### 1-2. Operation

The operation of multi-display device 200 configured as above will be described below.

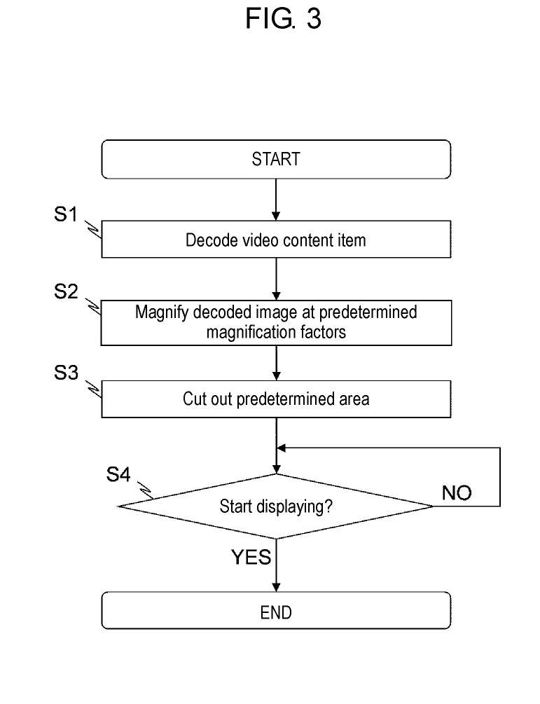

FIG. 3 is a flowchart illustrating the operation of multi-display device 200 according to the first exemplary embodiment. Incidentally, in this exemplary embodiment, the displays each have the same configuration, and therefore the operation of display 210 is described as a representative example. In other words, not only display 210 but also displays 220, 230 and 240 receive the compressed video content item from video content server 100.

Communicator 211 of display 210 receives, through the network, the video content item that has been compressed by an arbitrary compression method, and that has been transmitted from video content server 100. The received video content item is transmitted to video processor 212, and is then decoded by using the most suitable decoding method (step S1). A method such as H.264 and H.265 is known as a general method for compressing a moving image content item, and a method such as JPEG is known as a method for compressing a still image content item. In step S1, from information given to the video content item processed by video processor 212, controller 215 is capable of obtaining information about the received video content item such as the video compression method, the audio compression method, the video display resolution, and the display frame rate.

Controller 215, which has obtained the information about the video content item, then instructs video processor 212 to magnify the video content item at predetermined magnification factors that are suitable for displaying of the multi-display device. Video processor 212 magnifies the video content item, which has been decoded in step S1, at the predetermined magnification factors according to the instruction (step S2).

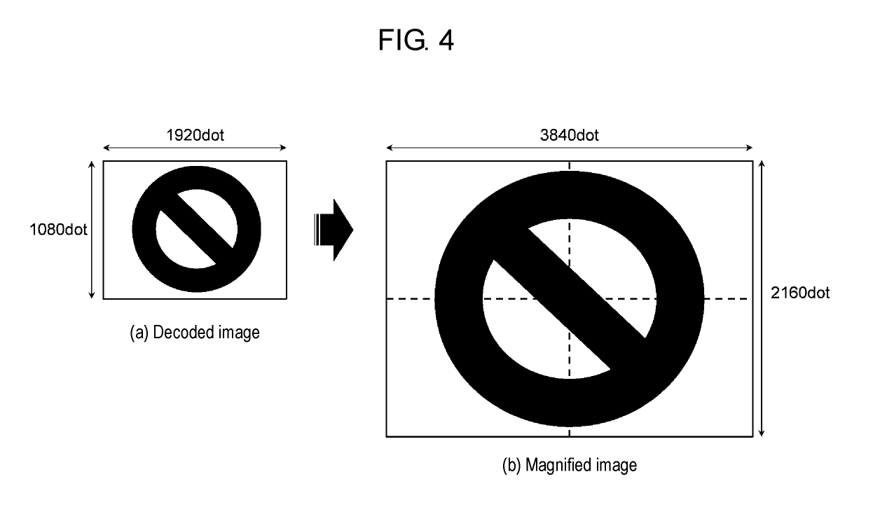

The operation of step S2 will be described with reference to FIG. 4. FIG. 4(a) shows an example of a decoded image of the video content item, the decoded image having been decoded in step S1 and having a resolution of horizontally 1920 dots and vertically 1080 dots. Meanwhile, in the multi-display device having a configuration such as that shown in FIG. 1, when the displays each have a resolution of horizontally 1920 dots and vertically 1080 dots, the resolution of the multi-display device as a whole is calculated as follows:

Horizontal resolution=1920 dots×2=3840 dots; and

Vertical resolution=1080 dots×2=2160 dots.

In other words, in order to display the decoded image of FIG. 4(a), which has been decoded in step S1, on the whole screen of the multi-display device having the configuration such as that shown in FIG. 1, it is necessary to calculate magnification factors. In the case of this example, magnification factors in both directions are calculated as follows:

Horizontal magnification factor=3840 dots/1920 dots=twice; and

Vertical magnification factor=2160 dots/1080 dots=twice.

These magnification factors are calculated by controller 215.

FIG. 4(b) illustrates an example of the video content item magnified at this time. In FIG. 4(b), four respective regions into which a magnified image is divided with broken lines correspond to respective areas displayed by respective displays 210 to 240.

In step S2, in order to calculate the magnification factors, controller 215 is required to grasp a configuration (a number of displays) of the multi-display device including display 210. Inputting the number of displays by an operator beforehand enables controller 215 to grasp the number of displays. More specifically, there may be mentioned a method in which referring to a menu screen displayed by display unit 213, an operator inputs vertical and horizontal numbers of displays as a screen configuration by remote operation.

Incidentally, FIG. 4 shows the example in which the resolution of the multi-display device as a whole is larger than the resolution that the video content item has. However, even in the reverse case, it is similarly possible to perform magnified displaying. In addition, FIG. 4 shows the example in which the horizontal magnification factor and the vertical magnification factor have the same numerical value. However, even when the horizontal magnification factor and the vertical magnification factor have respective numerical values different from each other, it is similarly possible to perform magnified displaying.

After the decoded image is magnified at the predetermined magnification factors in step S2, video processor 212 cuts out an image area based on a position at which display 210 is arranged (step S3).

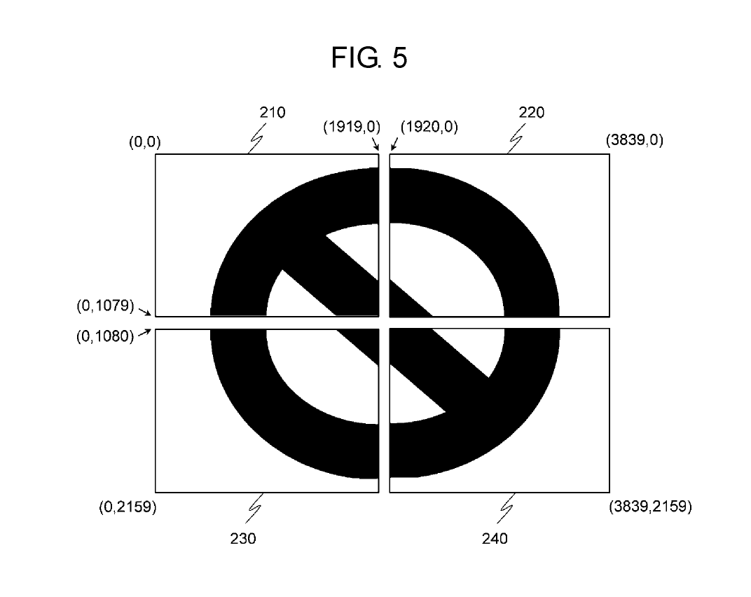

The operation of step S3 will be described with reference to FIG. 5. When the video content item that is magnified as shown in FIG. 4(b) is displayed by displays 210 to 240, the video content item is displayed as shown in FIG. 5. Display 210 constituting a part of multi-display device 200 is arranged on the upper left part of multi-display device 200. Therefore, in a coordinate system of the magnified image of the video content item in FIG. 4(b), display 210 ranges as follows:

Horizontal range=from 0th to 1919th dots; and
Vertical range=from 0th to 1079th dots.

In other words, from the image magnified in step S2, controller 215 instructs video processor 212 to display only the image located in this area on display 210. Video processor 212 outputs the image located in the predetermined area to display unit 213 according to the received instruction.

Moreover, controller 215 performs time adjustment through communicator 211 so as to synchronize the time managed by display 210 with the time managed by each of the other displays 220, 230, and 240. As this time adjustment method, there are a method in which the time managed by time synchronizer 214 is adjusted to the reference time of an NTP (Network Time Protocol) server, which is provided outside, through the network, and a method in which any one of the displays in the multi-display device is used as a time master, and the time managed by each of the other displays is adjusted to the time of the display that takes charge of the time master function. The time managed by each of the displays in the multi-display device can be unified in this manner.

Next, when controller 215 instructs display unit 213 to display the image located in the predetermined area generated in step S3 (for example, the image to be displayed on display 210), display unit 213 displays the image in the desired timing (step S4).

As with the multi-display device, when one video content item is displayed by using a plurality of displays, it is necessary to synchronize the display timing between the displays. Accordingly, as described above, the time managed by each of the displays is unified in the whole multi-display device to display the image located in the predetermined area by each of the displays according to an arbitrary display scenario. The desired video content item can be displayed on the whole screen of the multi-display device in this manner without causing a sense of discomfort. An example of the display scenario is indicated as follows:

10:00:00—Reproduce moving image 1;
10:10:00—Reproduce still image 1;
10:10:30—Reproduce still image 2; and
10:11:00—Reproduce moving image 2.

For example, respective display images of moving image 1 that are suitable for positions at which the respective displays are arranged are generated in step S3. In addition, controller 215 refers to the time of time synchronizer 214, and then instructs display unit 213 to output the generated image from 10:00:00. Managing the display scenario by each of the displays in this manner enables the video content item of moving image 1 to be displayed on the whole screen of the multi-display device without causing a sense of discomfort.

### Modified Example

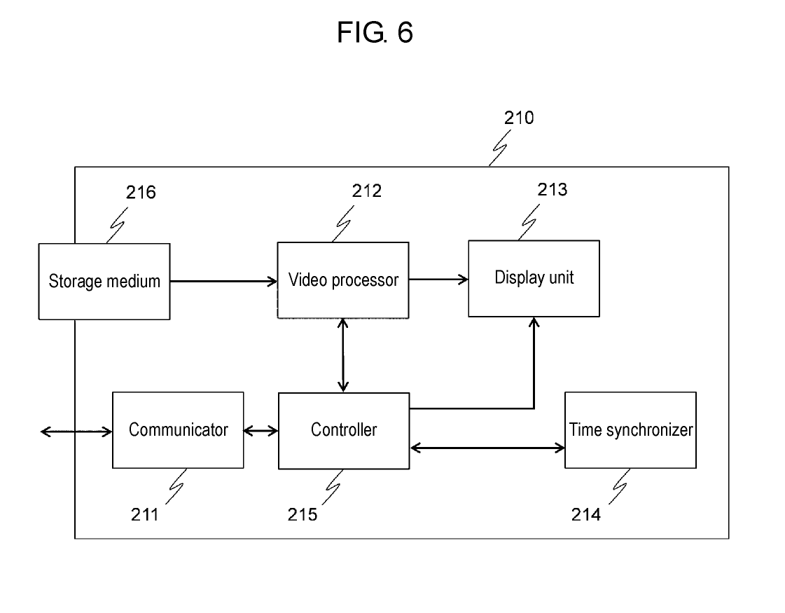

FIG. 6 is a block diagram illustrating a configuration of a modified example of the multi-display device according to the first exemplary embodiment. Incidentally, the same reference numerals are used for a block that is similar to that shown in the block diagram of FIG. 2, and the description thereof will be omitted.

The video content item to be displayed by multi-display device 200 may be stored in storage medium 216 without being transmitted from video content server 100 to each of displays 210 to 240 through the network. Storage medium 216 is, for example, an SD card or an USB memory device, both of which can be built into each of displays 210 to 240. In addition, video processor 212 that is controlled by controller 215 processes the video content item stored in storage medium 216 according to a flowchart shown in FIG. 3, and consequently the desired video content item can be displayed in the desired timing without causing a sense of discomfort.

### 1-3. Effects and the Like

As described above, in the first exemplary embodiment, gasping the whole configuration of the multi-display device beforehand, and then unifying the time managed by each of the displays that constitute the multi-display device, enables one content item to be displayed on the whole screen of the multi-display device without causing a sense of discomfort, without using a dividing device for dividing the video content item, and with the display timing synchronized between the displays.

### Second Exemplary Embodiment

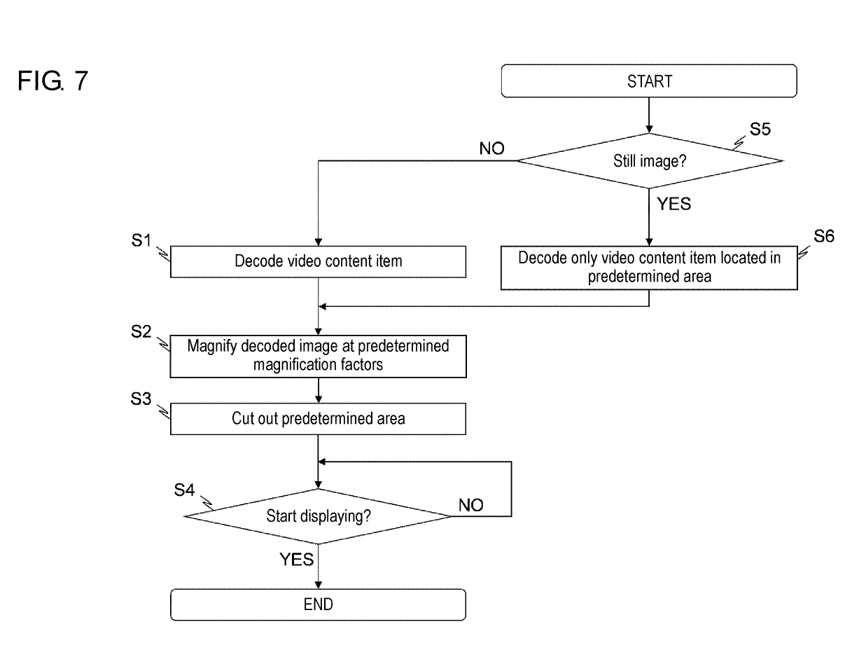

A second exemplary embodiment will be described below with reference to FIG. 7.

### 2-1. Configuration

The configuration itself is the same as the configuration in FIGS. 1 and 2 described in the first exemplary embodiment, and therefore the description thereof will be omitted.

### 2-2. Operation

FIG. 7 is a flowchart illustrating the operation of a multi-display device according to the second exemplary embodiment. In the flowchart shown in FIG. 7, the same reference numerals are used to denote the same processing steps as those described in the first exemplary embodiment, and the description thereof will be omitted.

In general, a JPEG format is used as a compressed file format for still images. This JPEG compression method usually compresses an area of 8 dots×8 dots as one block. For example, as shown in FIG. 4(a), in the case of a still image having a resolution of 1920 dots×1080 dots, the still image can be subdivided as follows:

Horizontally 1920 dots/8 dots=240 blocks; and
Vertically 1080 dots/8 dots=135 blocks.

In other words, in FIG. 1, for example, when display 220 (one of the displays that constitute multi-display device 200) decodes the video content item in step S1, display 220 is enabled to decode only a part located in a predetermined area without decoding the whole video content item. In this case, the video processor of display 220 is enabled to obtain an image located in a desired area by decoding only the following blocks:

Horizontally 240 blocks/2 (calculated from the horizontal magnification factor)=120 blocks; and
Vertically 135 blocks/2 (calculated from the vertical magnification factor)=67.5 blocks, in other words,
Horizontally from the 121st block to the 240th block; and
Vertically from the 1st block to the 68th block.

However, in the case of the compression method such as JPEG, there is correlation between adjacent blocks. Therefore, in actuality, it is common practice to expand a region that includes adjacent blocks at a ratio of several percent.

In FIG. 7, controller 215 determines whether or not an input video content item is a still image content item (step S5). When the input video content item is not a still image content item, it is not possible to limit a range of decoding to a desired area only. Therefore, as shown in the flowchart of FIG. 3, a process proceeds to step S1, and the desired area is output from each of the displays in a predetermined timing.

In step S5, when it is determined that the input video content item is a still image content item that is based on a format in which a range of decoding can be limited to an image located in a desired area only, controller 215 instructs (controls) video processor 212 to decode only the video content item located in the desired area. Video processor 212 decodes the video content item according to the received instruction (step S6).

Only the video content item located in the desired area is decoded in step S6, and as shown in the flowchart of FIG. 3 as well, the process proceeds to step S2, in which the decoded image located in the desired area is output from each of the displays in the predetermined timing. Here, the operation of cutting out the desired area in step S3 can be omitted when only the video content item located in the desired area has been decoded in step S6. However, when the decoded video content item includes a block adjacent to the desired area, an unnecessary area must not be included in step S3.

### 2-3. Effects and the Like

As described above, in the second exemplary embodiment, providing the step for determining whether or not the video content item to be displayed is a still image content item eliminates the need for decoding the whole area of the video content item by each of the displays, thereby enabling a remarkable decrease in the decoding time required to decode the video content item in the video processor. Thus, for example, when still image content items are successively displayed, intervals between a still image content item that is currently being displayed and a still image content item to be subsequently displayed can be shortened, enabling enhancement of the flexibility of the expression method for expressing still image content items.

Incidentally, the exemplary embodiments described above are intended to illustrate the techniques in the present disclosure, and therefore various changes, replacements, additions, omissions and the like may be made within the scope or range of equivalents of the claims.

The present disclosure can be applied to a multi-display device composed of a plurality of displays that are connected through a network to display one screen. More specifically, the present disclosure can be applied to a video wall system, a signage system and the like, each of which is composed of a plurality of liquid crystal displays.

What is claimed is:

1. A multi-display device comprising a plurality of displays that are connected through a network, and that are combined to display one video, the plurality of displays each including:
a communicator that is capable of communicating through the network;
a video processor that decodes an arbitrary video content item, and identifies a display area based on an arrangement of each of the displays;
a display unit that displays an image located in the area identified by the video processor;
a time synchronizer that synchronizes, through the communicator, a timing of displaying the image by the display unit between the plurality of displays; and
a controller that controls the communicator, the video processor, the display unit, and the time synchronizer.

2. The multi-display device according to claim 1, wherein the video content item is the same for all of the plurality of displays.

3. The multi-display device according to claim 1, wherein the controller controls the video processor in such a manner that when the video content item is a still image, the video processor decodes only the still image located in a specific display area based on the arrangement of each of the displays.

4. The multi-display device according to claim 2, wherein the controller controls the video processor in such a manner that when the video content item is a still image, the video processor decodes only the still image located in a specific display area based on the arrangement of each of the displays.

5. The multi-display device according to claim 1, further comprising a storage medium for storing the video content item,
wherein the controller controls the video processor in such a manner that the video processor decodes the video content item stored in the storage medium.
